(19) United States
(12) Patent Application Publication
(10) Pub. No.: US 2009/0030137 A1
(43) Pub. Date: Jan. 29, 2009

(54) Polyacetal-ultrahigh molecular weight polyethylene blends

(76) Inventor: Ramabhadra Ratnagiri, Wilmington (DE)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/881,210

(22) Filed: Jul. 26, 2007

(51) Int. Cl. C08L 23/06

(52) U.S. Cl. 524/507

(57) ABSTRACT

Polyacetal composition comprising polyacetal, ultrahigh molecular weight polyethylene, and a compatibilizer comprising ethylene/vinyl acetate copolymer and, optionally, at least one epoxy-containing compound.

### FIELD OF THE INVENTION

The present invention relates to melt-mixed blends of polyacetal and ultrahigh molecular weight polyethylene compatibilized with ethylene/vinyl acetate copolymers and, optionally, epoxy compounds.

### BACKGROUND OF THE INVENTION

Many applications require that parts made from polymeric materials be in motion with respect to other parts they are in physical contact with. In such cases, it is desired that the polymeric materials have good wear resistance to avoid erosion of the surface of the parts at the point of contact. An example of such an application is a conveyor belt system where there is continuous contact between the conveyor elements and the structure supporting the elements while the conveyor is operating.

Ultrahigh molecular weight polyethylene (UHMWPE) is often used in applications requiring good wear resistance. UHMWPE has excellent resistance to abrasive wear, very high impact toughness, a low coefficient of friction, and good chemical resistance. However, its flexural modulus is not always high enough for certain applications and it is restricted to applications requiring low temperatures (its useful upper temperature is believed to be about 75° C.) and low speed contact. Additionally, in wear applications involving the presence of hard abrasive particles, the particles can have a tendency to imbed in the soft UHMWPE, leading to increased wear. Furthermore, it lacks significant melt extensibility, meaning that it can not be drawn in the melt. Thus, shaping processes to form articles from UHMWPE are typically limited to non-melt processes, such as ram extrusion and compression molding. Further, UHMWPE is not generally suitable for use with conventional melt-processing techniques (e.g. injection molding, melt extrusion, etc.), which limits the variety of articles that can be conveniently made.

Polyacetals (also known as polyoxymethylenes or POM) are known to have excellent tribology and good physical properties and have low friction when in contact with steel surfaces. Polyacetals can be used at temperatures above 90° C. and are generally melt-processable. However, the wear surfaces of polyacetals tend to become gouged with extended use.

Polyacetal/UHMWPE melt-mixed blends can show improved wear resistance relative to UHMWPE and can be fabricated using conventional melt-processing techniques. However, these blends are often not as tough as desired and exhibit low percentages of elongation at break.

It would be desirable to have polyacetal/UHMWPE blend that has improved elongation at break without having significantly decreased wear resistance.

U.S. Patent Application Publication 2006/0074175 discloses a process for preparing shaped articles from high molecular weight polyacetal powder and, optionally, ultrahigh molecular weight polyethylene. U.S. Patent Application Publication 2007/0015869 discloses compositions comprising high molecular weight polyacetal and ultrahigh molecular weight polyethylene.

### SUMMARY OF THE INVENTION

Disclosed herein is a polyacetal composition comprising a blend of;
(A) about 60 to about 99 weight percent of at least one polyacetal, and
(B) about 1 to about 40 weight percent of an ultrahigh molecular weight polyethylene and compatibilizer component, comprising;
   (B1) about 70 to about 98 weight percent ultrahigh molecular weight polyethylene, and
   (B2) about 2 to about 30 weight percent of compatibilizer, comprising;
      (C1) about 50 to about 100 weight percent ethylene/vinyl acetate copolymer,
      (C2) 0 to about 50 weight percent of at least one epoxy-containing compound;
         wherein the weight percentages of (A) and (B) are based on the total weight of the composition; the weight percentages of (B1) and (B2) are based on the total weight of compatibilizer component (B); and the weight percentages of (C1) and (C2) are based on the total weight of compatibilizer (B2).

### DETAILED DESCRIPTION OF THE INVENTION

The polyacetal composition of the present invention is a melt-mixed blend comprising at least one polyacetal (A) and an ultrahigh molecular weight polyethylene (UHMWPE) and compatibilizer component (B). The UHMWPE-compatibilizer component comprises UHMWPE (B1) and compatibilizer (B2) comprising at least one ethylene/vinyl acetate copolymer (C1) and, optionally, at least one epoxy-containing compound (C2).

The polyacetals (A) in the composition of the present invention can be one or more homopolymers, copolymers, or a mixture thereof. Homopolymers are prepared by polymerizing formaldehyde and/or formaldehyde equivalents, such as cyclic oligomers of formaldehyde. Copolymers are derived from one or more comonomers generally used in preparing polyacetals in addition to formaldehyde and/formaldehyde equivalents. Commonly used comonomers include acetals and cyclic ethers that lead to the incorporation into the polymer chain of ether units with 2-12 sequential carbon atoms. If a copolymer is selected, the quantity of comonomer will not be more than 20 weight percent, preferably not more than 15 weight percent, and most preferably about two weight percent. Preferable comonomers are 1,3-dioxolane, ethylene oxide, and butylene oxide, where 1,3-dioxolane is more preferred, and preferable polyacetal copolymers are copolymers where the quantity of comonomer is about 2 weight percent. It is also preferred that the homo- and copolymers are: 1) homopolymers whose terminal hydroxy groups are end-capped by a chemical reaction to form ester or ether groups; or, 2) copolymers that are not completely end-capped, but that have some free hydroxy ends from the comonomer unit or are terminated with ether groups. Preferred end groups for homopolymers are acetate and methoxy and preferred end groups for copolymers are hydroxy and methoxy. The polyacetal will preferably be linear (unbranched) or have minimal chain-branching. The polyacetal will preferably have a number average molecular weight of at least 10,000, or preferably of at least about 60,000, or more preferably of at least about 90,000, or still more preferably of greater than 100,000, or yet more preferably of at least about 103,000. In one embodiment of the invention, the polyacetal will have a number average molecular weight in the range of greater than 100,000 to about 300,000.

Number average molecular weight is determined by gel permeation chromatography using a light scattering detector. In one embodiment of the invention, the polyacetal will preferably have a melt flow rate of about 0.5 g/10 min or less or more preferably about 0.4 g/10 min or less, or yet more preferably about 0.3 g/10 min or less, as measured at 190° C. under a 2.16 kg load, following ISO method 1133.

The polyacetal may be prepared using any conventional method. In particular, when polyacetals having high molecular weights are used, it will be apparent to those skilled in the art that it will be necessary to ensure that the monomers and solvents used in the preparation of the polyacetal be of sufficient purity to minimize the likelihood of chain-transfer reactions that would prevent the desired high molecular weights from being obtained during the polymerization. This will often require that the concentration of chain-transfer agents such as water and/or alcohols be kept to a minimum. See, for example, K. J. Persak and L. M. Blair, “Acetal Resins,” Kirk-Othmer Encyclopedia of Chemical Technology, 3^{rd} Edition, Vol. 1, Wiley, New York, 1978, pp. 112-123.

The at least one polyacetal (A) is present in about 60 to about 99 weight percent, or preferably in about 75 to about 95 weight percent, based on the total weight of the composition.

The ultrahigh molecular weight polyethylene (UHMWPE) (B1) used in the present invention is polyethylene with a number average molecular weight that is at least about 3×10⁶. Ultra high molecular weight polyethylenes are defined by ASTM D 4020-01a to be those linear polymers of ethylene that have a relative viscosity of 1.44 or greater, as measured at 0.02 g/ml in decalin at 135° C. The nominal viscosity molecular weight defined by the above method is at least 3.12×10⁶ g/mol.

The ethylene/vinyl acetate copolymer (C1) is a thermoplastic polymer derived from the polymerization of ethylene and vinyl acetate. The ethylene/vinyl acetate copolymer may additionally contain repeat units derived from other monomers, such as carbon monoxide (resulting in an ethylene/vinyl acetate/carbon monoxide polymer). The ethylene/vinyl acetate copolymer is preferably derived from at least about 20 weight percent, or more preferably about 20 to about 50 weight percent, or even more preferably about 35 to about 45 weight percent vinyl acetate monomers.

The epoxy-containing compound (C2) can be monomer, oligomeric, or polymeric. Oligomeric and polymeric compounds are preferred. Suitable epoxy containing compounds include diphenolic epoxy condensation polymers. As used herein, “diphenolic epoxy condensation polymer” means a condensation polymer having epoxy functional groups, preferably as end groups, and a diphenol moiety within the polymer. Such diphenolic epoxy condensation polymers are well-known to those of ordinary skill in the art.

A preferred diphenolic epoxy condensation polymer is the following:

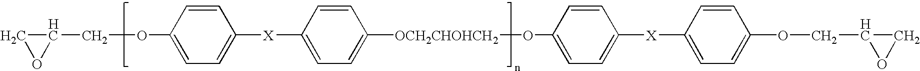

where n=1-16 and X is —C(CH₃)₂—; —SO₂—; —C(CF₃)₂—; —CH₂—; —CO—; or —CCH₃C₂H₅—.

Since n represents an average, it need not be a whole number. X may be the same throughout the polymer or may change throughout the polymer. Preferably, X is —C(CH₃)₂.

Preferred diphenolic epoxy condensation polymers include condensation polymers formed by the condensation reaction of epichlorohydrin with at least one diphenolic compound. Also preferred is a 2,2-bis(p-glycidyloxyphenyl) propane condensation product with 2,2-bis(p-hydroxyphenyl)propane and similar isomers.

Preferred commercially available diphenolic epoxy condensation polymers include the EPON® 1000 series of resins (1001F-1009F), available from Shell Chemical Co. Particularly preferred are EPON® 1001F, EPON® 1002F, and EPON® 1009F.

The epoxy compound may comprise a compound comprising at least two epoxy groups per molecule of the compound, and preferably at least three epoxy groups per molecule of the compound, and more preferably at least four epoxy groups per molecule of the compound. Even more preferably, this compound comprises between two and four epoxy groups per molecule of the compound. The epoxy groups of this compound preferably comprise glycidyl ethers, and even more preferably, glycidyl ethers of phenolic compounds. This compound may be polymeric or non-polymeric, with non-polymeric being preferred. A preferred commercially available embodiment is EPON® 1031 (available from Shell Chemical Co.), which is believed to be primarily a tetraglycidyl ether of tetra (parahydroxyphenyl)ethane.

The epoxy compound may also contain glycidyl groups. Examples include polymers derived from monomers that include glycidyl acrylate and/or glycidyl methacrylate. Other monomers can include ethylene and acrylic esters and/or methacrylic esters. A preferred glycidyl-group containing epoxy compound is ethylene/n-butyl acrylate/glycidyl methacrylate terpolymer (EBAGMA).

The UHMWPE/compatibilizer component (B) is present in the composition in about 1 to about 40 weight percent, or preferably in about 5 to about 25 weight percent, based on the total weight of the composition.

The UHMWPE/compatibilizer component (B) comprises about 70 to about 98 weight percent UHMWPE (B1) and about 2 to about 30 weight percent compatibilizer (B2), or preferably, about 85 to about 95 weight percent UHMWPE (B1) and about 5 to about 15 weight percent compatibilizer (B2), where the weight percentages of (B1) and (B2) are based on the total weight of component (B).

The compatibilizer (B2) comprises about 50 to about 100 weight percent ethylene/vinyl acetate copolymer (C1) and, optionally, up to about 50 weight percent of at least one epoxy-containing compound (C2), or preferably, about 50 to about 90 weight percent ethylene/vinyl acetate copolymer (C1) and about 10 to about 50 weight percent of at least one epoxy-containing compound (C2), where the weight percentages of (C1) and (C2) are based on the total weight of compatibilizer (B2).

The composition of the present invention may optionally comprise other additives such as lubricants, processing aids, stabilizers (such as thermal stabilizers, oxidative stabilizers, ultraviolet light stabilizers), colorants, nucleating agents, compatibilizers, tougheners, fluoropolymer such as poly(tetrafluoroethylene), plasticizers, reinforcing agents and fillers (such as glass fibers, wollastonite, mineral fillers, and nanofillers).

The polyacetal compositions of the present invention are made by melt-blending the components using any known or conventional methods. The component materials may be mixed thoroughly using a melt-mixer such as a single or twin-screw extruder, blender, kneader, Banbury mixer, etc. to give a resin composition. Or, part of the materials may be mixed in a melt-mixer, and the rest of the materials may then be added and further thoroughly melt-mixed.

The compositions of the present invention can be formed into articles using any suitable technique known in the art, such as melt-processing techniques. Commonly used melt-molding methods known in the art such as injection molding, extrusion molding, blow molding, rotational molding, coining, and injection blow molding are preferred and injection molding is more preferred. The compositions of the present invention can be formed into sheets and both cast and blown films by extrusion. These films and sheets may be further thermoformed into articles and structures that can be oriented from the melt or at a later stage in the processing of the composition. The compositions may be overmolded onto an article made from a different material. The articles may also be formed using techniques such as compression molding or ram extruding. The articles may be further formed into other shapes by machining.

Examples of suitable articles include gears; rods; sheets; strips; channels; tubes; conveyor system components such as wear strips, guard rails, rollers, and conveyor belt parts.

### EXAMPLES

### Compositions

The compositions of the examples and comparative examples were prepared by compounding the components given in Tables 1-5 on a W&P 30 mm co-rotating twin-screw extruder. A dry-blend of all ingredients was premixed in a drum tumbler and fed to the feed throat of the extruder. The barrel temperatures were maintained at 190-210° C. and a 4 mm-diameter die-head was used to form strands that were cut into to 3 mm long pellets.

In the case of the polyacetal ingredients, the amount in weight percent given in the tables corresponds to the indicated polyacetal plus the following additives: 0.025 weight percent Acrawax® C (supplied by Lonza, Inc, Fairlawn, N.J.), 0.07 weight percent Irganox® 245 and 0.025 weight percent Irganox® 1098 (supplied by Ciba Specialty Chemicals Corp, Tarrytown, N.Y.), and 0.475 weight percent polyacrylamide, where the forgoing weight percentages are based on the total weight of the composition and the remainder of the weight is polyacetal.

### Physical Testing

The pellets were then injection molded with a mold temperature of 90° C., a melt temperature of 215° C. and a cycle time of 65 s into specimens for tensile and flexural testing. An ASTM Type IV tensile specimen mold as outlined in test method D 638 was used for the tensile specimens and a mold as outlined in ASTM D 256 for Izod-Type Test specimens was used for specimens for notched Izod impact energy measurements.

Young's modulus, elongation at yield and elongation at break were measured according to ASTM D 638. The area under the stress-strain curve was also calculated and denoted as energy to break in the following tables. For all the tests the results were averaged over five specimens.

### Thermal Stability

The thermal stability of the compositions was determined by heating pellets of the compositions for about 30 minutes at a temperature of 259° C. The formaldehyde evolved during the heating step is swept by a stream of nitrogen into a titration vessel containing a sodium sulfite solution where it reacts with the sodium sulfite to generate sodium hydroxide. The generated sodium hydroxide is continuously titrated with hydrochloric acid to maintain the original pH. The total volume of acid used is plotted as a function of time. The total volume of acid consumed at 30 minutes is proportional to the formaldehyde generated by the heated polyoxymethylene and is a quantitative measure of thermal stability. The percent thermal stability (referred to as TEF-T) is calculated by the following formula:

TEF-T(%)=(V₃₀×N×3.003)/S

where:

V₃₀=the total volume in mL of acid consumed at 30 minutes,

N=the normality of the acid,

3.003=(30.03 (the molecular weight of formaldehyde)×100%)/(1000 mg/g), and

S=the sample weight in grams.

The results are shown in Tables 1-4 under the heading of “TEF-T.”

### Wear Testing

The compositions of Comparative Example 11 and Example 17 were molded into modified thrust washers as described in ASTM D3702. Comparative Example 10 uses a thrust washer machined from a sheet of UHMWPE. The wear resistance of these materials was tested as follows: An amorphous PET (poly(ethylene terephthalate)) washer was run against stationary thrust washers under a load of 10 psi at a rate of 130 feet/min. After an initial break-in period, a state-state wear rate was observed and the corresponding wear rate was calculated. The results are reported in Table 5.

The following ingredients are used in the Examples and Comparative Examples:
Polyacetal A refers to a polyoxymethylene homopolymer having a number average molecular weight of about 29,000.
Polyacetal B refers to a polyoxymethylene homopolymer having a number average molecular weight of about 35,000.
Polyacetal C refers to a polyoxymethylene homopolymer having a number average molecular weight of about 66,000.
Polyacetal D refers to a polyoxymethylene homopolymer having a number average molecular weight of about 105,000.
EVA refers to an ethylene/vinyl acetate copolymer in which 40 weight percent of the repeat units are derived from vinyl acetate and that has a melt index of 52 g/10 min as measured at 190° C. with a weight of 2.16 kg in accordance with ASTM D1238.
UHMWPE refers to Mipelon™ XM220, supplied by Mitsui Chemicals America, Inc., Purchase, N.Y.
Epoxy compound A refers to an ethylene/n-butyl acrylate/glycidyl methacrylate terpolymer.
Epoxy compound B refers to EPON® 1002F, a solid epoxy resin derived from liquid epoxy resin and bisphenol A and having an epoxide equivalent weight of 600-700 according to ASTM D1652 and supplied by Hexion Specialty Chemicals.
EMA refers to EMAC® SP2205, an ethylene/methyl acrylate copolymer derived from 20 weight percent methyl acrylate monomer and supplied by Eastman Chemical Company.
Olefin copolymer refers to Engage® 8402, an ethylene/1-octene copolymer supplied by Dow Performance Elastomers.

TABLE 1

| | Comp | Comp. | | | | | | |
|---|---|---|---|---|---|---|---|---|
| | Ex. 1 | Ex. 2 | Ex. 1 | Ex. 2 | Ex. 3 | Ex. 4 | Ex. 5 | Ex. 6 |
| Polyacetal D | 80 | 80 | 80 | 80 | 80 | 80 | 80 | 80 |
| UHMWPE | 20 | 18 | 19.5 | 19 | 18 | 16 | 17 | 17 |
| EVA | — | 2 | 0.5 | 1 | 2 | 4 | 2 | 2 |
| Epoxy compound A | — | — | — | — | — | — | 1 | — |
| Epoxy compound B | — | — | — | — | — | — | — | 1 |
| Elongation at break (%) | 11 | 20 | 17 | 17 | 20 | 18 | 19 | 13 |
| Young's modulus (MPa) | 2700 | 2400 | 2500 | 2450 | 2400 | 2350 | 2500 | 2600 |
| Energy to break (J) | 8.6 | 17.7 | 14.3 | 13.9 | 17.7 | 15.9 | 16.3 | 11.3 |
| Notched Izod impact energy (J/m) | 52.3 | 45.4 | 50.7 | 49.1 | 45.4 | 51.2 | 47.5 | 64.1 |
| TEF-T | 1.73 | 1.84 | 2.02 | 1.49 | 1.84 | 2.45 | 1.41 | 1.04 |

Ingredient quantities are given in weight percentages based on the total weight of the composition.

TABLE 2

| | Comp. | | | Comp. | Comp. | Comp. | Comp. |
|---|---|---|---|---|---|---|---|
| | Ex. 3 | Ex. 7 | Ex. 8 | Ex. 4 | Ex. 5 | Ex. 6 | Ex. 7 |
| Polyacetal D | 80 | 80 | 80 | 80 | 80 | 80 | 80 |
| UHMWPE | 20 | 18 | 16 | 18 | 16 | 18 | 16 |
| EVA | — | 2 | 4 | — | — | — | — |
| EMA | — | — | — | 2 | 4 | — | — |
| Olefin copolymer | — | — | — | — | — | 2 | 4 |
| Elongation at break (%) | 8 | 16 | 19 | 9 | 7 | 7 | 6 |
| Young's modulus (MPa) | 2600 | 2500 | 2500 | 2500 | 2550 | 2400 | 2500 |
| Energy to break (J) | 5.6 | 14.8 | 17.4 | 7 | 5.5 | 5.3 | 3.7 |
| Notched Izod impact energy (J/m) | 65 | 60.9 | 62.7 | 66.1 | 63.7 | 64.6 | 71.8 |
| TEF-T | 1.95 | 2.54 | 2.39 | 2.13 | 1.58 | 1.96 | 1.79 |

Ingredient quantities are given in weight percentages based on the total weight of the composition.

TABLE 3

| | Comp | | | Comp | | | Comp | | |
|---|---|---|---|---|---|---|---|---|---|
| | Ex. 8 | Ex. 9 | Ex. 10 | Ex. 9 | Ex. 11 | Ex. 12 | Ex. 10 | Ex. 13 | Ex. 14 |
| Polyacetal A | 80 | 80 | 80 | — | — | — | — | — | — |
| Polyacetal B | — | — | — | 80 | 80 | 80 | — | — | — |
| Polyacetal C | — | — | — | — | — | — | 80 | 80 | 80 |
| UHMWPE | 20 | 18 | 17 | 20 | 18 | 17 | 20 | 18 | 17 |
| EVA | — | 2 | 2 | 0 | 2 | 2 | 0 | 2 | 2 |
| Epoxy compound A | — | — | 1 | — | — | 1 | — | — | 1 |
| Elongation at break (%) | 11 | 14 | 15 | 13 | 15 | 17 | 12 | 19 | 21 |
| Young's modulus (MPa) | 2530 | 2420 | 2430 | 2420 | 2440 | 2400 | 2300 | 2300 | 2320 |
| Energy to break (J) | 7.3 | 9.6 | 10 | 9.2 | 10.4 | 11.9 | 8.8 | 13.7 | 15.5 |
| Notched Izod impact energy (J/m) | 28.3 | 27.2 | 28.8 | 28.3 | 28.8 | 29.9 | 27.2 | 30.4 | 31.5 |
| TEF-T | 2.57 | 2.16 | 1.84 | 2.1 | 1.86 | 1.64 | 2.09 | 1.82 | 1.64 |

Ingredient quantities are given in weight percentages based on the total weight of the composition.

TABLE 4

| | Comp | | Comp. | | Comp | | Comp. | |
|---|---|---|---|---|---|---|---|---|
| | Ex. 11 | Ex. 15 | Ex. 12 | Ex. 16 | Ex. 13 | Ex. 17 | Ex. 14 | Ex. 18 |
| Polyacetal D | 95 | 95 | 90 | 90 | 85 | 85 | 80 | 80 |
| UHMWPE | 5 | 4.25 | 10 | 8.5 | 15 | 12.75 | 20 | 17 |
| EVA | — | 0.5 | — | 1 | — | 1.5 | — | 2 |
| Epoxy compound A | — | 0.25 | — | 0.5 | — | 0.75 | — | 1 |
| Elongation at break (%) | 30 | 31 | 20 | 26 | 13 | 21 | 10 | 17 |
| Young's modulus (MPa) | 3000 | 3000 | 2800 | 3000 | 2730 | 2600 | 2430 | 2480 |
| Energy to break (J) | 35.5 | 39.2 | 21.3 | 28.9 | 11.9 | 20 | 7.3 | 14 |
| TEF-T | 0.54 | 0.47 | — | — | — | — | — | — |

Ingredient quantities are given in weight percentages based on the total weight of the composition.

TABLE 5

| | Comp. | Comp. | |
|---|---|---|---|
| | Ex. 15 | Ex. 16 | Ex. 19 |
| Polyacetal D | — | 80 | 80 |
| UHMWPE | 100 | 20 | 17 |
| EVA | — | — | 2 |
| Epoxy compound A | — | — | 1 |
| Test duration (hr) | 15 | >65 | >65 |
| Wear rate (×10¹⁰ in³ · min/ft · lb · hr) | 970 | 138 | 160 |

Ingredient quantities are given in weight percentages based on the total weight of the composition.

What is claimed is:

1. A polyacetal composition comprising a blend of;
(A) about 60 to about 99 weight percent of at least one polyacetal, and
(B) about 1 to about 40 weight percent of an ultrahigh molecular weight polyethylene and compatibilizer component, comprising;
(B1) about 70 to about 98 weight percent ultrahigh molecular weight polyethylene, and
(B2) about 2 to about 30 weight percent of compatibilizer, comprising;
(C1) about 50 to about 100 weight percent ethylene/vinyl acetate copolymer,
(C2) 0 to about 50 weight percent of at least one epoxy-containing compound;
wherein the weight percentages of (A) and (B) are based on the total weight of the composition; the weight percentages of (B1) and (B2) are based on the total weight of compatibilizer component (B); and the weight percentages of (C1) and (C2) are based on the total weight of compatibilizer (B2).

2. The composition of claim 1, wherein the polyacetal has a number average molecular weight of at least about 60,000.

3. The composition of claim 1, wherein the polyacetal has a number average molecular weight of at least about 100,000.

4. The composition of claim 1, wherein the polyacetal has a number average molecular weight of at least about 103,000.

5. The composition of claim 1, wherein the polyacetal has a melt flow rate of about 0.5 g/10 min or less, as measured at 190° C. under a 2.16 kg, following ISO method 1133.

6. The composition of claim 1, wherein the polyacetal has a melt flow rate of about 0.3 g/10 min or less, as measured at 190° C. under a 2.16 kg, following ISO method 1133.

7. The composition of claim 1, wherein the ethylene/vinyl acetate copolymer (C1) is derived from about 20 to about 50 weight percent vinyl acetate monomers.

8. The composition of claim 1, wherein the epoxy containing compound (C2) is at least one diphenolic epoxy condensation polymer.

9. The composition of claim 8, wherein the diphenolic epoxy condensation polymer is at least one polymer formed from the condensation reaction of epichlorohydrin with at least one diphenolic compound.

10. The composition of claim 8, wherein the diphenolic epoxy condensation polymer is formed by the condensation reaction of 2,2-bis(p-glycidyloxyphenyl) propane with 2,2-bis(p-hydroxyphenyl)propane.

11. The composition of claim 1, wherein the epoxy containing compound is a polymer derived from monomers comprising glycidyl acrylate and/or glycidyl methacrylate.

12. The composition of claim 1, wherein the epoxy containing compound is ethylene/n-butyl acrylate/glycidyl methacrylate terpolymer.

13. The composition of claim 1, wherein the at least one polyacetal (A) is present in about 75 to about 95 weight percent and the ultrahigh molecular weight polyethylene and compatibilizer component (B) is present in about 5 to about 25 weight percent, where the weight percentages are based on the total weight of the composition.

14. An article formed from the composition of claim 1.

15. The article of claim 14 in the form of an injection molded article.

16. The article of claim 14 in the form of a rod, sheet, strip, channel, or tube.

17. The article of claim 14 in the form of a gear.

18. The article of claim 14 in the form of conveyer system wear strip, guard rail, roller, or conveyer belt part.
